(19) United States
(12) Patent Application Publication
(10) Pub. No.: US 2025/0101754 A1
(43) Pub. Date: Mar. 27, 2025

(54) LADDER HANDRAIL SAFETY DEVICE

(71) Applicant: Ballymore Company, Inc., Coatsville, PA (US)

(72) Inventor: William F. Frame, Coatsville, PA (US)

(21) Appl. No.: 18/891,437

(22) Filed: Sep. 20, 2024

Related U.S. Application Data
(60) Provisional application No. 63/584,211, filed on Sep. 21, 2023.

(51) Int. Cl. E04G 5/14; E04G 1/24; E04G 5/10

(52) U.S. Cl. CPC E04G 5/14; E04G 1/24; E04G 5/10; E04G 2001/246

(57) ABSTRACT

A ladder handrail safety device includes a plurality of spaced bands disposed on one or more of the ladder handrails to notify the user when the user is approaching the bottom step while descending, and a mat on the bottom step. Each band may be fabricated from a PET aluminum foil tape or a polymer tape.

### CROSS REFERENCE TO RELATED APPLICATIONS

This application claims priority to U.S. Provisional Patent Application Ser. No. 63/584,211 filed Sep. 21, 2023

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The Invention relates to a ladder handrail safety device.

### SUMMARY

A ladder handrail safety device includes a plurality of spaced bands disposed on one or more of the ladder handrails to notify the user when the user is approaching the bottom step while descending, and a mat on the bottom step. Each band may be fabricated from a PET aluminum foil tape or a polymer tape.

The spaced bands preferably provide both a tactile and visual indication which provide the user notification. A mat or colored surface may be provided on or as part of the bottom step which also provides a visual indication to the user in conjunction with the spaced bands.

### BRIEF DESCRIPTION OF THE DRAWINGS

The embodiments will be described in detail with reference to the following drawings in which like reference numerals refer to like elements wherein:

FIG. 1 shows a side view of a rolling ladder having an attached ladder handrail safety device in accordance with the present invention.

FIG. 2 shows a front view of the ladder handrail safety device of FIG. 1.

FIG. 3 shows an enlarged side view of the ladder handrail safety device of FIG. 1.

FIG. 4 shows an enlarged front perspective view of the ladder handrail safety device of FIG. 1.

### DETAILED DESCRIPTION

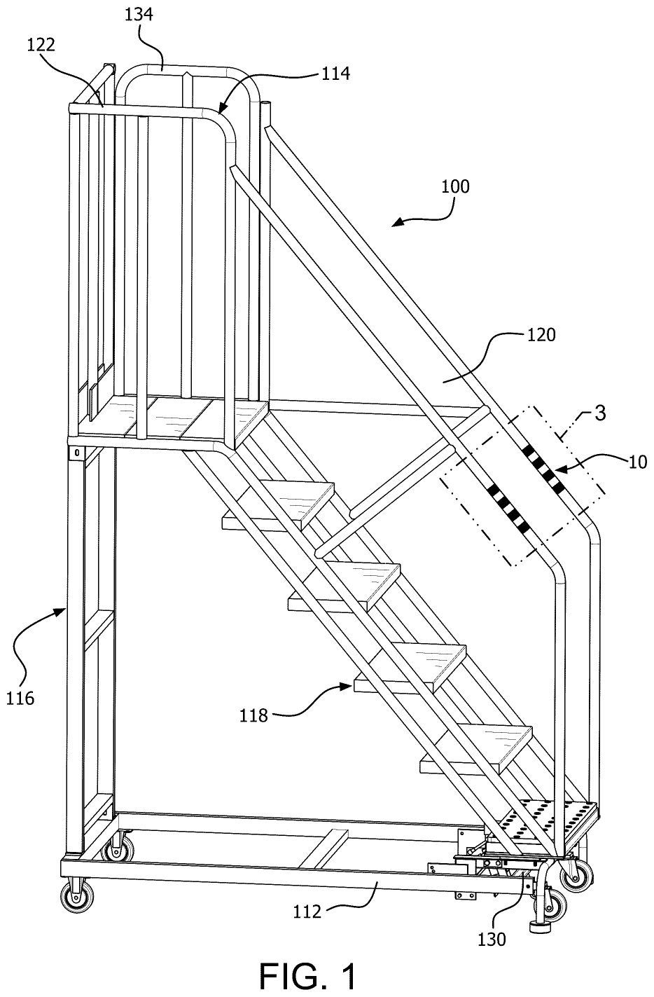

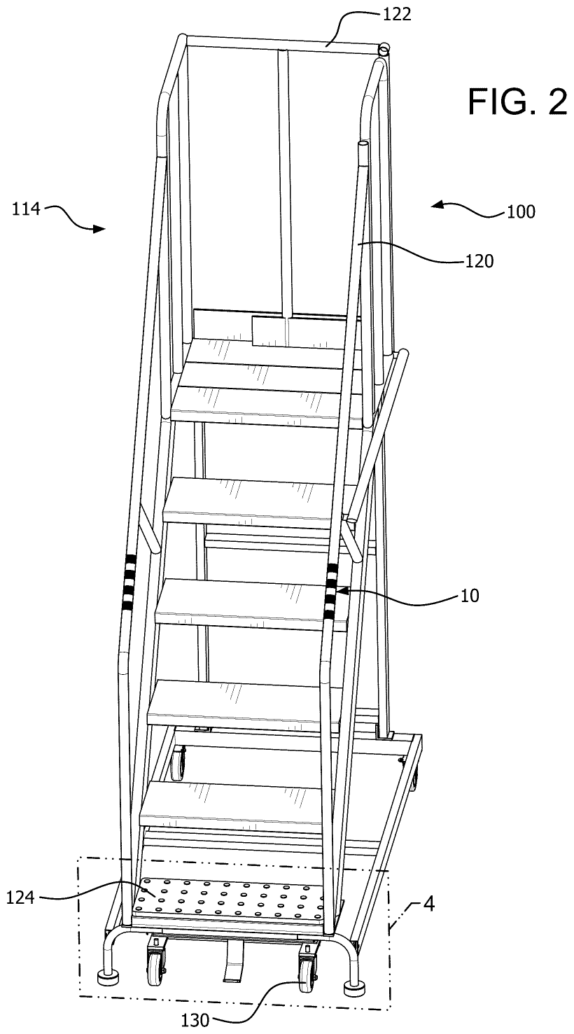

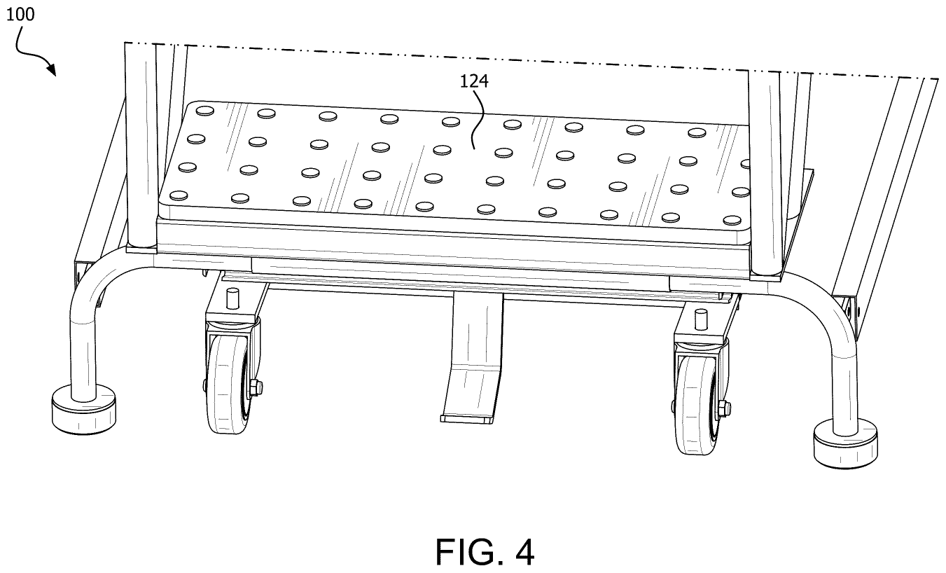

In FIG. 1-4, there is shown a preferred embodiment of a ladder handrail safety device 10 disposed on a representative ladder system 100.

The typical rolling ladder system 100 includes a base 112. An enlarged top stair 114 is attached to the base 112 via a pair of vertical uprights at a rear end. A stair section 118 connects the front of the top stair 118 to a front portion of the base 112. A pair of user handrails 120 on the stair section 118 and extend from the handrails 122 located around the top stair to the bottom step 124 of the stair section 118.

A lift assist lock step 130 may also be included as well as a locking swingable gate 134 disposed on an inner side location.

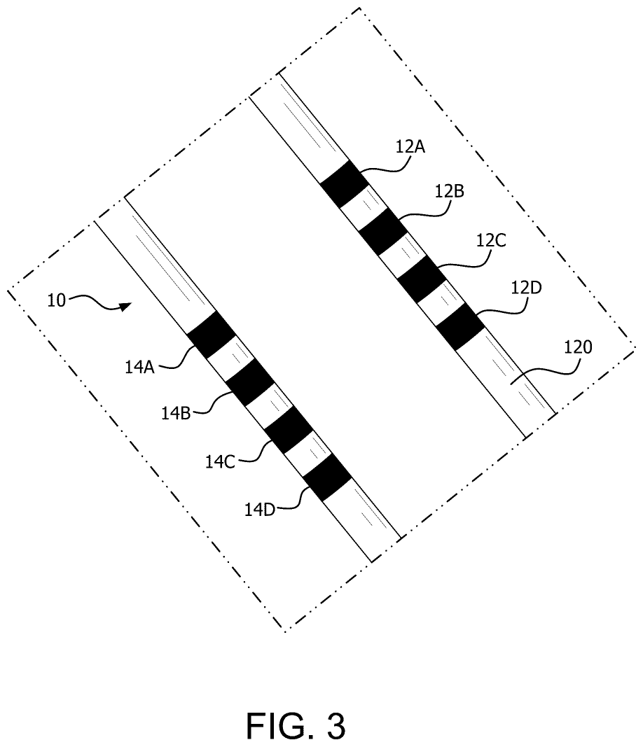

The ladder handrail safety device 10 is best seen in FIG. 3 and includes a series of bands 12A-12D and 14A-14D disposed on each handrail 120. The bands 12A-12D and 14A-14B provide both a tactile and visual warning to the user. The bands 12A-12D and 14A-14B are configured to have a thickness around the circumference of the handrail 120 sufficient to provide the user with the tactile indication that the user is approaching the bottom stair 124. The bands 12A-12D and 14A-14B are also adapted to have a readily noticeable, bright highly visual color which provides a visual indicator as well that the user is approaching the bottom stair 124 as the user descends the ladder. The location of the approaching the bottom stair 124 on the handrails is determined by where the hands of a typical user are located as the user is reaching the bottom step 124 as the user descends the ladder.

The handrail safety device 10 further includes that the bottom step 124 has a mat which is similar or identical readily noticeable, bright highly visual color as the bands 12A-12D and 14A-14B. The mat and bands work in conjunction with the bottom step mat to enhance the safety of the user descending the ladder. The mat may also be or include indicia or a colored surface of the bottom step 124.

In one form of the invention the bands are fabricated from PET aluminum foil tape. In another form of the invention, the bands are fabricated from polymer tape, but other suitable materials such as fitted polymers are also contemplated which are more durable and faster to install

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A ladder handrail safety device comprising:
a plurality of spaced bands disposed on one or more ladder handrails to notify the user when the user is approaching the bottom step while descending the ladder.

2. The ladder handrail safety device according to claim 1 wherein the spaced bands provide both a tactile and visual indication which provide the user notification.

3. The ladder handrail safety device according to claim 1 further comprising a mat on the bottom step which also provides a visual indication to the user in conjunction with the spaced bands.

4. The ladder handrail safety device according to claim 1 wherein the spaced bands are each a PET aluminum foil tape.

5. The ladder handrail safety device according to claim 3 wherein the bottom step includes indicia or a colored surface also provides a visual indication to the user in conjunction with the spaced bands

6. A ladder comprising: a ladder handrail safety device comprising, a plurality of spaced bands disposed on one or more of the ladder handrails to notify the user when the user is approaching the bottom step while descending, and a mat on the bottom step.
